(19) United States
(12) Patent Application Publication
(10) Pub. No.: US 2008/0221851 A1
(43) Pub. Date: Sep. 11, 2008

(54) Aid design system for analog integrated circuit and the method thereof

(75) Inventors: Dong Min Chen, Hsinchu City (TW); Chen Chang Peng, Hsinchu City (TW)

Correspondence Address: OLIFF & BERRIDGE, PLC, P.O. BOX 320850, ALEXANDRIA, VA, 22320-4850, US

(73) Assignee: ADVANCED ANALOG TECHNOLOGY, INC., HSINCHU (TW)

(21) Appl. No.: 11/730,150

(22) Filed: Mar. 29, 2007

(30) Foreign Application Priority Data
Mar. 7, 2007 (TW) 096107783

(51) Int. Cl. G06F 17/50

(52) U.S. Cl. 703/14

(57) ABSTRACT

The aid design system for analog ICs includes an analog IC database, a peripheral component database, an input module, a computing simulation module, a selection module and an output module. The analog IC database includes parameters of a plurality of analog ICs. The peripheral component database includes parameters of the peripheral components cooperating with the analog ICs. The input module is for use in inputting a desirable parameter specification or specific IC according to the user's discretion. The computing simulation module includes transfer functions of the analog ICs. The selection module is for use in picking out suggested peripheral components based on the computing result of the computing simulation module. The output module is for use in displaying the suggested peripheral components or analog ICs.

### BACKGROUND OF THE INVENTION

1. Field of the Invention

The present invention relates to an aid design system and method for analog integrated circuits (ICs), and more particularly, to an aid design system and method for selecting peripheral components of analog ICs to perform an entire circuit simulation.

2. Description of the Related Art

Nowadays there are many aid design systems for digital ICs, but a well-defined aid design system for analog ICs which satisfies the user's need is rarely seen. This is because the digital ICs are easy to standardize and only need to consider logic zero and one. Besides, the component connection between digital ICs is easier than that between analog ICs. However, it is difficult to build up standard analog ICs, not only because individual companies manufacture product specifications that are inconsistent with each other, but also for some peripheral components, such as inductors, capacitors and diodes, whose parasitic capacitor needs to be considered when building up the entire circuit performance.

Generally speaking, most design flows of analog ICs need to look up the datasheet of the analog ICs involved. However, those datasheets are recorded in accordance with approximate mathematical model, which is inexact in the first place. Thereafter, users need to look up manuals of peripheral components to choose suitable peripheral components. Because most datasheets neglect the parasitic effect of the peripheral components, the users need to make a test board to physically test the output response and steady state analysis of the entire circuit including the analog ICs and the peripheral components. The above design flow usually involves a try error method to iteratively modify the selected components several times, and thus users would waste a lot of energy and time.

Because the technique of power ICs has been developed for several years, many models in connection with power converters, such as boost and buck, have been published. For example, the team led by Professor Marian K. Kazimierczuk published a lot of transfer functions of boost current mode converters and peak currents of boost inductors in IEEE Journals. Please refer to B. Bryant and M. K. Kazimierczuk, “Open-loop power-stage transfer functions relevant to current-mode control of boost PWM converter operating in CCM,” IEEE Trans. Circuits Syst., Part 1, vol. 52, pp. 2158-2164, October 2005. B. Bryant and M. K. Kazimierczuk,” Modelling the Closed-Current Loop of PWM Boost DC-DC Converters Operating in CCM with Peak Current-Mode Control,” IEEE Trans. Circuits Syst., Part 1, vol. 52, pp. 2404-2412, November 2005. B. Bryant and M. K. Kazimierczuk,” Voltage Loop of Boost PWM DC-DC Converters with Peak Current-Mode Control,” IEEE Trans. Circuits Syst., Part 1, vol. 53, pp. 99-105, January 2006. Because the computing capability of current computers is very strong, the simulation of the power converters using the above mathematical model is more and more accurate. However, if the above model simulation only considers analog ICs themselves and not users' needs, it would be less helpful to save time and energy for designers.

In short, finding a system and method to reduce the complexity of the design flow for analog ICs is an important issue right now.

### SUMMARY OF THE INVENTION

The aid design system and method for analog ICs of the present invention is to help analog IC designers to automatically list the desired peripheral components. The present invention automatically lists suggested peripheral components from a peripheral component database according to the user's demand and simulation in the analog IC database. Thereafter, an estimated efficiency, output response and steady state analysis are displayed for the user's reference. Therefore, the present invention makes a more convenient design environment for users, and reduces the number of times needed to look up datasheet and try errors, thereby shortening the time to design product applications of analog ICs. The aid design system and method for analog ICs of the present invention can be used in any calculation platform, such as a personal computer, network server, smart phone or PDA.

The aid design system according to an embodiment of the present invention includes an analog IC database, a peripheral component database, an input module, a calculation simulation module, an output module and a selection module. The analog IC database includes a plurality of parameters of analog ICs. The peripheral component database includes parameters of the peripheral components cooperating with the analog ICs. The input module is configured so that a user can input a specification. The calculation simulation module connects to the input module, analog IC database and peripheral component database. The calculation simulation module includes transfer functions and equations of the plurality of analog ICs. The output module is configured to display suggested peripheral components according to the simulation result of the calculation simulation module. The selection module is configured to select peripheral components from the suggested peripheral components, where the selected peripheral component is submitted into the calculation simulation module to proceed with an entire circuit simulation.

The aid design method for analog ICs according to an embodiment of the present invention includes steps (a) to (f). In step (a), a user inputs a specification of a desired analog IC. In step (b), the aid design system calculates and lists all peripheral components satisfying the specification. In step (c), the user chooses peripheral components from the listed peripheral components. In step (d), the aid design system performs an entire circuit simulation including the analog IC and the chosen peripheral component. In step (e), the user determines whether the simulation result is acceptable. In step (f), the user reselects another analog IC or peripheral component and performs another entire circuit simulation if the result is not acceptable.

### BRIEF DESCRIPTION OF THE DRAWINGS

The invention will be described according to the appended drawings in which:

FIG. 1 shows an aid design system for analog ICs according to the present invention;

FIG. 2 shows an aid design method for analog ICs according to one embodiment of the present invention;

FIG. 3 shows a user interface according to one embodiment of the invention;

FIG. 4 shows a stability analysis according to an embodiment of the present invention; and

FIG. 5 shows a transient response according to an embodiment of the present invention.

### PREFERRED EMBODIMENT OF THE PRESENT INVENTION

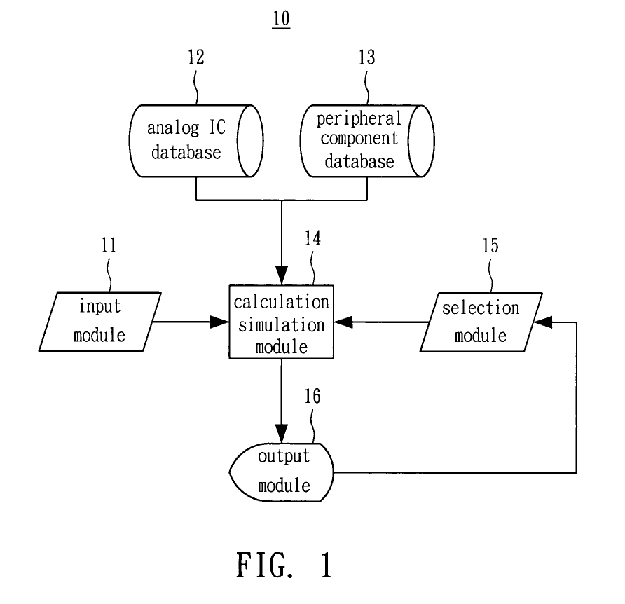

FIG. 1 shows an aid design system 10 for analog ICs according to the present invention, which includes an analog IC database 12, a peripheral component database 13, an input module 11, a calculation simulation module 14, a selection module 15 and an output module 16. The analog IC database 12 includes parameters of well-defined analog ICs, such as the structure of boost analog ICs, current feedback compensation and the gain of amplifiers, which are built up in advance. The analog IC database 12 can continuously update and append its content by means of the console of the calculation platform or through the Internet. The peripheral component database 13 includes parameters of peripheral components, which cooperate with the analog ICs together, for example, an inductor with 10 μH, a current with rate current 2.1 Amperes and DCR with 100 mΩ, a capacitor with 22 μH and ESR with 50 mΩ. Similarly, the peripheral component database 13 can continuously update and append its content by means of the console or through the Internet. The input module 11 accepts the specification or desired analog ICs chosen by users, for example, input voltage 2V to 3V, output voltage 5V/500 mA, etc. The calculation simulation module 14 simulates system efficiency according to well-prepared transfer functions and formulae. The output module 16 displays suggested peripheral components or analog ICs according to the result of the calculation simulation module 14. The user can use the selection module 15 to pick out his or her desired peripheral component from the suggested list of the output module 16. Alternatively, the user can manually pick his or her desired peripheral component, which is not among the suggested list, and then re-simulate the entire circuit, for example, first calculate an inductor operating in a continuous conduction mode (CCM) and then choose inductance value 6.8 μH with rate current greater than 1.6 A. The peripheral component after selection will re-enter the calculation simulation module 14 to calculate the efficiency of the entire circuit. Thereafter, the output module 16 will display application properties of the entire circuit, such as steady state response, transient response and estimated efficiency.

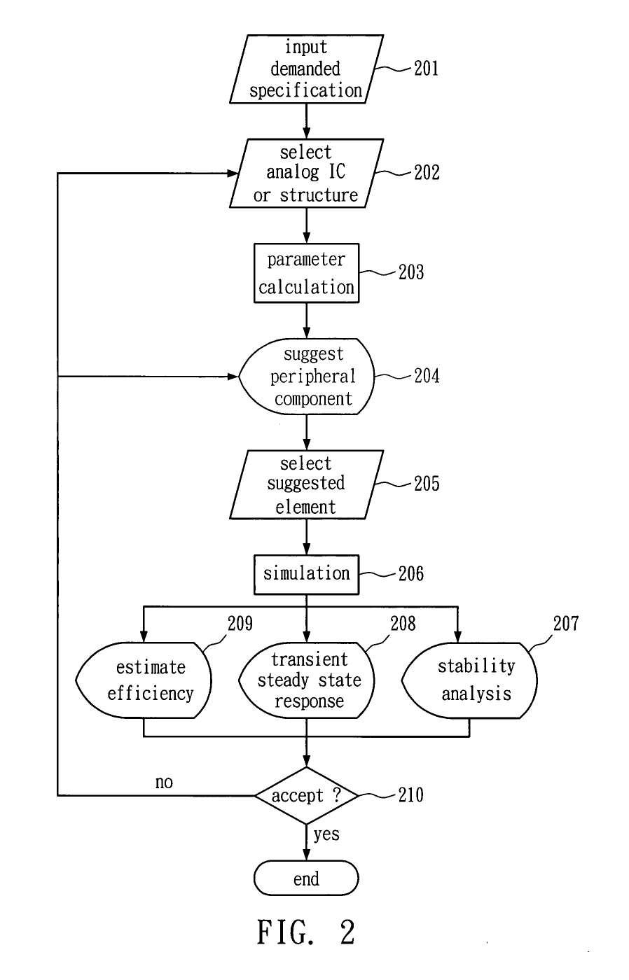

FIG. 2 shows an aid design method for analog ICs according to one embodiment of the present invention. In step 201, a user inputs the desired specification in the input module 11. In step 202, the user chooses analog ICs or the desired structure from the analog IC database 12. In step 203, after the analog IC or structure is ascertained, the calculation simulation module 14 does a parameter calculation. In step 204, the output module 16 outputs the desired peripheral component. In step 205, the user chooses from the suggested peripheral components. In step 206, the system proceeds with a simulation test according to total parameters. From steps 207 to 209, after simulation, the output module 16 will estimate efficiency, output transient and steady state response, and stability analysis. In step 210, the user determines whether the simulation result is acceptable. If the user thinks the response time is not fast enough or the stability is not very good, then the design flow returns to step 202 or 204 to iterate until a satisfactory result is achieved.

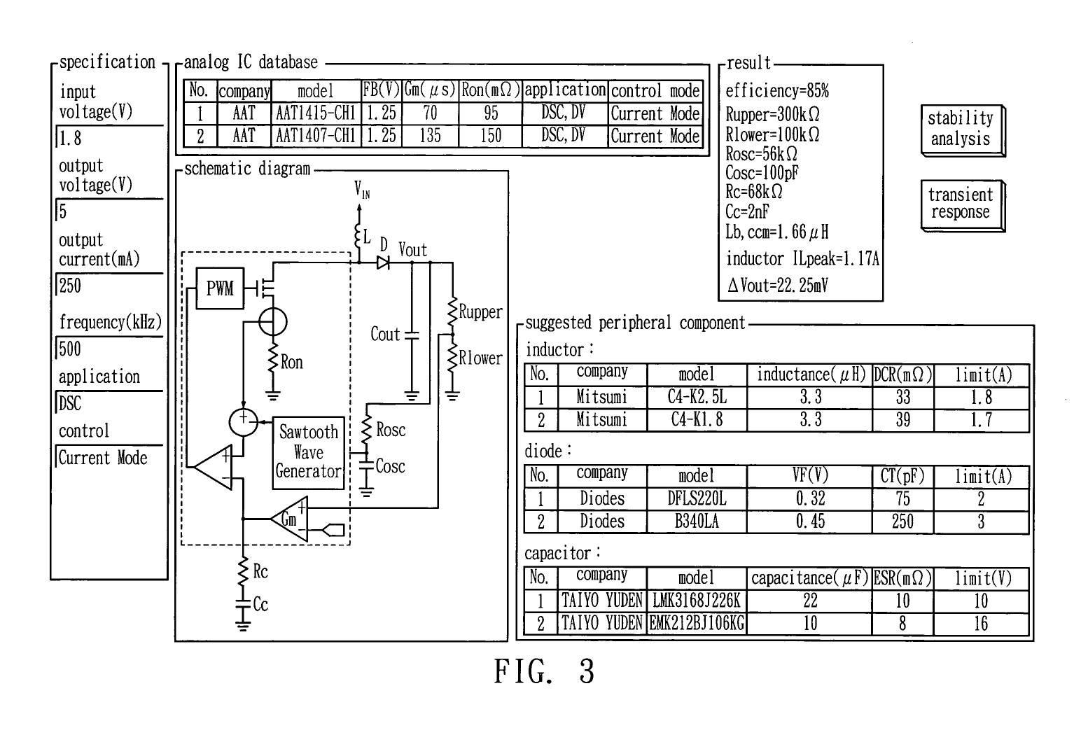

FIG. 3 shows a user interface according to one embodiment of the invention. Assume that the client needs a boost analog IC used in a digital camera, including the specification as the following:

Vᵢₙ=1.8V, Vₒᵤₜ=5V, Iₒ=250 mA, f_{sw}=500 kHz

where Vᵢₙ represents input voltage, Vₒᵤₜ represents output voltage, Iₒ represents output current and f_{sw} represents switching frequency. The user inputs the specification requested by his or her customer to the aid design system 10 for analog ICs of the present invention, such as the “specification” field on the left side of FIG. 3. In the meantime, the system begins to calculate and recommends all possible analog ICs. For example, the “analog IC database” field at the top of FIG. 3 shows two sets of qualified models and parameters. The “schematic diagram” field in the middle of FIG. 3 shows an analog IC with model no. AAT1415 and its peripheral component. The “result” field in the top right corner of FIG. 3 shows parameters of the peripheral components cooperating with the AAT1415 analog IC, and the total efficiency is thereby calculated. The “suggested peripheral component” field in the bottom right corner of FIG. 3 further recommends a suitable model no. of the peripheral components.

For example, according to the specification demand of f_{sw}=500 kHz, AAT1415 will set up its frequency based on C_{OSC}=100 pF, R_{OSC}=56 k Vₒᵤₜ=5V, and therefore the voltage-dividing resistor is as follows:

$${R}_{lower} = 100 k , {R}_{upper} = {R}_{lower} \times ( \frac{{V}_{out}}{IN 1} - 1 ) = 100 k \times ( \frac{5}{1.25} - 1 ) = 300 k .$$

The duty cycle and critical inductance value are as follows:

$$D = 1 - \frac{{V}_{in}}{{V}_{out}} = 1 - \frac{1.8}{5} = 0.64$$

$${L}_{B , CCM} = \frac{{R}_{LOAD} \cdot D \cdot {( 1 - D )}^{2}}{2 \cdot {f}_{sw}} = \frac{5 / 0.25 \times 0.64 \times {( 1 - 0.64 )}^{2}}{2 \times 500 k} = 1.66 µ$$

Because the circuit has a higher efficiency in CCM, an inductance value greater than 1.66μ must be chosen. The embodiment chooses a normally used inductor with 3.3μ. The peak current of the inductor is as below:

$${I}_{L , peak} = \frac{{I}_{o}}{η \cdot ( 1 - D )} + \frac{{V}_{out} \cdot D \cdot ( 1 - D )}{2 \cdot {f}_{sw} \cdot L} = \frac{0.25}{0.85 \times ( 1 - 0.64 )} + \frac{5 \times 0.64 \times ( 1 - 0.64 )}{2 \times 500 k \times 3.3 µ} = 1.17 ( A )$$

Therefore, the current limit must pick one greater than 1.17 A.

The embodiment collects a suitable list from the peripheral component database 13. Assume that using Mitsumi C4-K2.5L as the conductor is recommended, which has a current limit with 1.8 A and DCR with 33 mΩ. Assume that using DFLS220L as the diode is recommended, which has a current limit with 2A, VF=0.32 and CT=75 pF. The compensation capacitor C_{c} is calculated as below:

$${C}_{c} = \frac{[ {R}_{L} ( 1 - D ) - \frac{{r}_{L} + {Dr}_{DS} + ( 1 - D ) {R}_{F}}{( 1 - D )} ]}{{R}_{s}} \cdot \frac{IN 1}{{V}_{out}} \cdot \frac{{g}_{m}}{4 \cdot π \cdot {f}_{c}}$$

Where R_{L} represents equivalent loading, r_{L} represents DCR of inductor, r_{DS} represents conductance resistance of inner MOS, R_{F} represents forward equivalent resistance of diode, Rₛ represents resistance of current sense, and f_{c} represents cross-over frequency. In CCM there is a zero point in the right half plane, whose frequency is

$${f}_{RHPZ} = \frac{{{R}_{L} ( 1 - D )}^{2} - ( {r}_{L} + {Dr}_{DS} + ( 1 - D ) {R}_{F} )}{2 π L}$$

Normally, a crossover frequency f_{c} will be set to lower than 20% from the switching frequency f_{RHPZ}. The embodiment chooses f_{RHPZ}≈115.7 kHz, and further decides f_{c}=20 kHz and C_{c}≈1.86 nF. In order to satisfy the above requirement, a normally used capacitance C_{c}=2.2 nF is chosen. The compensation resistor is

$${R}_{c} = \frac{{R}_{s} \cdot {I}_{L , peak}}{gm \cdot FB \cdot TD \%} ,$$

where TD % represents the percentage of transient drop. Assume the demand is 5%, and then R_{c}≈66.86 k is inferred. The embodiment picks a normally used resistance R_{c}=68 k. Also, a loading pole of a voltage-regulating capacitor is selected to offset the zero point caused by R_{c}C_{c}, where

$${R}_{c} {C}_{c} = \frac{1}{2} {C}_{out} ( {R}_{L} + 2 {r}_{c} ) .$$

As such, Cₒᵤₜ≈14.95 uF. The embodiment recommends the capacitor of YAIYO YUDEN LMK316BJ226K, which has Cₒᵤₜ=22 uF, ESR=10 mΩ and outputs ripple voltage

$$Δ {V}_{out} \approx \frac{{I}_{o} \cdot D}{{f}_{sw} \cdot {C}_{out}} + {I}_{L , peak} * ESR = 26.25 mV .$$

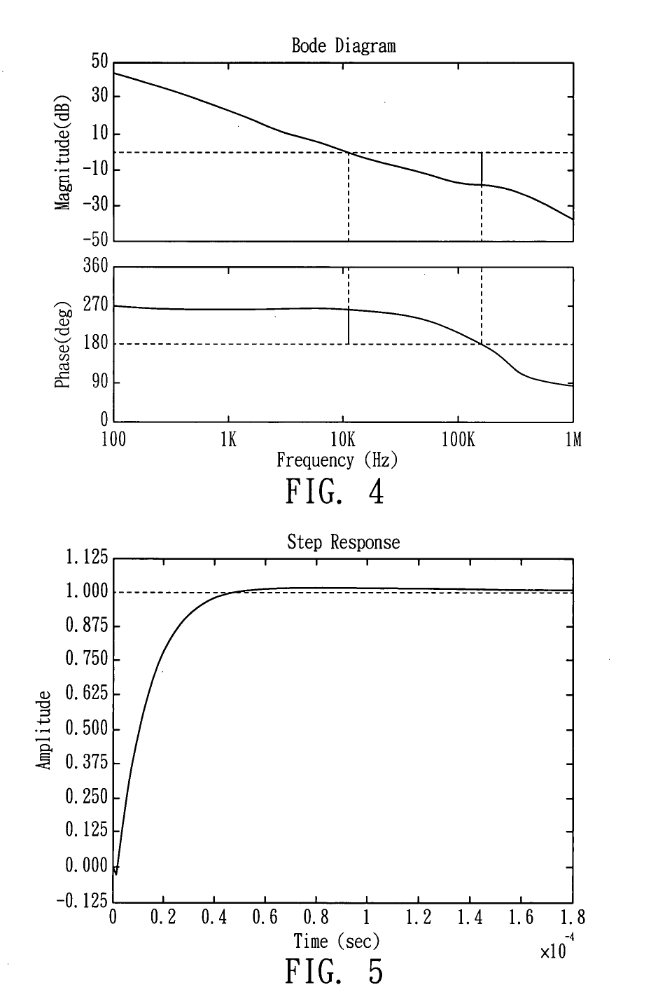

There are two buttons, “stability analysis” and “transient response” on the top right side of FIG. 3. After the selection of the peripheral component, the stability analysis and transient response proceed and the result appears in FIGS. 4 and 5. The user can determine whether the simulation result is acceptable. If the answer is no, the user can reselect another analog IC or peripheral components and perform another entire circuit simulation in accordance with the same flow chart described above.

The above-described embodiments of the present invention are intended to be illustrative only. Numerous alternative embodiments may be devised by persons skilled in the art without departing from the scope of the following claims.

What is claimed is:

1. An aid design system for analog integrated circuits (ICs), comprising:
an analog IC database including a plurality of parameters of analog ICs;
a peripheral component database including parameters of the peripheral components cooperating with the analog ICs;
an input module configured so that a user can input a specification;
a calculation simulation module connected to the input module, analog IC database and peripheral component database, the calculation simulation module including transfer functions and equations of the plurality of analog ICs;
an output module configured to display suggested peripheral components according to the simulation result of the calculation simulation module; and
a selection module configured to select a peripheral component from the suggested peripheral components, wherein the selected peripheral component is submitted into the calculation simulation module in order to proceed with an entire circuit simulation.

2. The aid design system of claim 1, wherein the output module displays a schematic diagram including the analog IC and peripheral components.

3. The aid design system of claim 1, wherein the input module allows the user to input or select a specific model number of analog ICs.

4. The aid design system of claim 1, wherein the output module displays parameters of all peripheral components calculated by the calculation simulation module.

5. The aid design system of claim 1, wherein the selection module allows the user to select a desired peripheral component which is not in the suggested list.

6. The aid design system of claim 1, wherein the entire circuit simulation includes one of stability analysis, transient response, steady state response and estimated efficiency.

7. An aid design method for analog ICs, comprising the steps of:
inputting a specification of a desired analog IC;
calculating and listing all peripheral components satisfying the specification with an aid design system;
choosing peripheral components from the listed peripheral components;
performing an entire circuit simulation including the analog IC and the chosen peripheral component with the aid design system;
determining whether the simulation result is acceptable; and
reselecting another analog IC or peripheral component and performing another entire circuit simulation if the result is not acceptable.

8. The aid design method of claim 7, further comprising the step of selecting a desired peripheral component which is not in the list.

9. The aid design method of claim 7, further comprising the step of inputting or selecting the desired structure of the analog ICs according to the user's discretion.

10. The aid design method of claim 7, wherein the entire circuit simulation includes one of stability analysis, transient response, steady state response and estimated efficiency.
